(19) United States
(12) Patent Application Publication
(10) Pub. No.: US 2020/0152947 A1
(43) Pub. Date: May 14, 2020

(54) Battery System Monitoring Device and Battery Pack

(71) Applicant: Hitachi Automotive Systems, Ltd., HItachinaka-shi, Ibaraki (JP)

(72) Inventors: Tomoyuki ARIMA, Hitachinaka-shi (JP); Tomonori KANAI, Hitachinaka-shi (JP); Tomoyasu FUSE, Hitachinaka-shi (JP)

(21) Appl. No.: 16/620,081

(22) PCT Filed: May 15, 2018
(86) PCT No.: PCT/JP2018/018657

§ 371 Date: Dec. 6, 2019

(30) Foreign Application Priority Data
Jun. 21, 2017 (JP) 2017-121394

(51) Int. Cl. H01M 2/20; H01M 2/34; B60L 50/64

(52) U.S. Cl. CPC H01M 2/206; B60L 50/64; H01M 2/34

(57) ABSTRACT

When a cell-switching jumper resistor is provided at a voltage detection line, measurement accuracy of a cell voltage is deteriorated due to an effect of the jumper resistor. Provided are cell voltage discharge lines connected to a cell voltage monitoring IC in order to discharge cell voltages of battery cells, and first jumper resistors that are mounted or are not mounted at cell voltage detection lines and the cell voltage discharge lines depending on whether or not each of the battery cells is used.

### TECHNICAL FIELD

The present invention relates to a battery system monitoring device and a battery pack.

### BACKGROUND ART

In hybrid vehicles (HEVs) and electric vehicles (EVs), an assembled battery (battery system) configured by connecting a plurality of battery cells which are secondary batteries in series is used in order to secure a desired high voltage. A battery system monitoring device including a cell voltage monitoring integrated circuit (IC) so as to correspond to a predetermined number of battery cells is provided in such an assembled battery.

States of the battery cells are monitored and managed by the cell voltage monitoring IC by performing measurement of voltages (cell voltages) between terminals of the battery cells and cell discharge for equalizing remaining capacities of the battery cells. During the discharge of each battery cell, a discharge current flows through a voltage detection line provided between each battery cell and the cell voltage monitoring IC via a discharge resistor. At this time, voltage drop corresponding to the magnitude of impedance occurs at the voltage detection line.

In recent years, battery cells with smaller voltage fluctuations due to changes in remaining capacity have been put into practical use. When such a battery cell is used, measurement accuracy higher than that in the related art is required in order to accurately estimate the remaining capacity by measuring the cell voltage. Thus, the effect of the voltage drop at the voltage detection line cannot be ignored in the measurement of the cell voltage during the discharge. PTL 1 describes a device that accurately measures the cell voltage by correcting the voltage drop at the voltage detection line.

In order to commonly use the battery control board of the battery system monitoring device so as to correspond to different numbers of battery cells, a cell-switching jumper resistor may be provided at the voltage detection line.

### CITATION LIST

### Patent Literature

PTL 1: JP 2011-75504 A

### SUMMARY OF INVENTION

### Technical Problem

When a cell-switching jumper resistor is provided at a voltage detection line, measurement accuracy of a cell voltage is deteriorated due to an effect of the jumper resistor.

### Solution to Problem

A battery system monitoring device according to the present invention includes a cell voltage monitoring circuit that detects cell voltages of a plurality of chargeable and dischargeable battery cells constituting an assembled battery by being connected in series and discharges the cell voltages of the battery cells so as to correspond to the battery cells, connection lines which are connected to positive electrodes and negative electrodes of the battery cells, cell voltage detection lines that are branched from the connection lines, and are connected the cell voltage monitoring circuit in order to detect the cell voltages of the battery cells, cell voltage discharge lines that are branched from the connection lines, and are connected to the cell voltage monitoring circuit in order to discharge the cell voltages of the battery cells, and first jumper resistors that are mounted or are not mounted at at least one line of a plurality of the cell voltage detection lines and at least one line of a plurality of the cell voltage discharge lines depending on whether or not each of the battery cells is used.

### Advantageous Effects of Invention

According to the present invention, it is possible to increase the detection accuracy of the cell voltage by removing the effect due to the cell-switching jumper resistor when the cell is discharged.

### BRIEF DESCRIPTION OF DRAWINGS

FIG. 1 is a circuit configuration of a battery system monitoring device.

FIGS. 2(a) and 2(b) each illustrate a circuit configuration of a battery system monitoring device according to a comparative example.

FIGS. 3(a) and 3(b) each illustrate a circuit configuration of a battery system monitoring device according to a first embodiment.

FIGS. 4(a) and 4(b) each illustrate a circuit configuration of a battery system monitoring device according to a second embodiment.

FIGS. 5(a) and 5(b) each illustrate a circuit configuration of a battery system monitoring device according to a third embodiment.

### DESCRIPTION OF EMBODIMENTS

Battery System Monitoring Device

Initially, a general battery system monitoring device will be described prior to the description of the present embodiment.

The battery system monitoring device according to the present embodiment is not limited to a device that monitors a battery system mounted on a hybrid vehicle (HEV). For example, the present invention can be widely applied to battery system monitoring devices that monitor battery systems mounted on plug-in hybrid vehicles (PHEV), electric vehicles (EV), and railway vehicles.

A lithium ion battery having a predetermined output voltage range, for example, an output voltage range of 3.0 V to 4.2 V (average output voltage: 3.6 V) is assumed as a minimum unit of the battery system to be controlled and monitored by the battery system monitoring device according to the present embodiment. However, the battery system monitoring device may control and monitor a battery system constituted by a charge and discharge device other than the lithium ion battery. That is, when a state of charge (SOC) is too high (overcharge) or too low (overdischarge) and thus, it is necessary to restrict the use of the device, the battery system may be constituted by any charge and discharge device. In the following description, the power charge and discharge device as a component of such a battery system is generically referred to as a battery cell. The charge and discharge device in which a plurality of battery cells are connected in series is called an assembled battery.

Hereinafter, an example of the battery system monitoring device will be described with reference to the drawings.

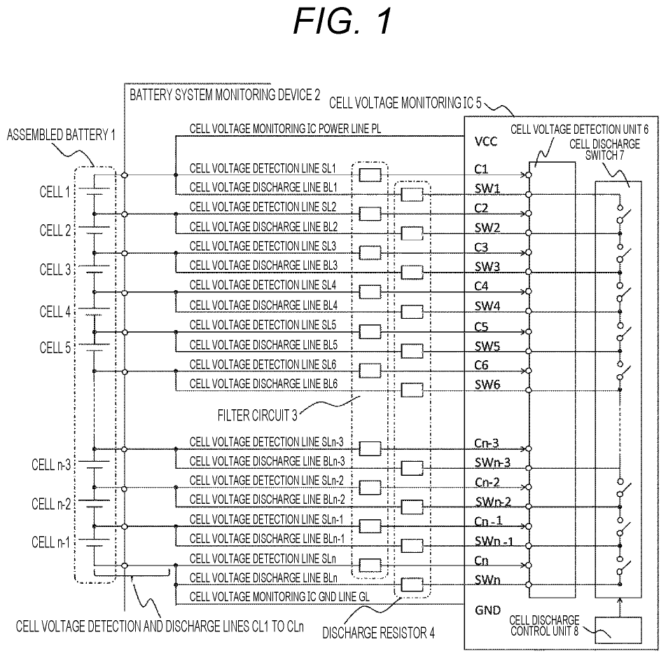

FIG. 1 is a diagram illustrating a configuration of a battery system monitoring device 2. The battery system monitoring device 2 is connected to an assembled battery 1 and includes filter circuits 3, discharge resistors 4, and a cell voltage monitoring IC 5. The cell voltage monitoring IC 5 includes a cell voltage detection unit 6, cell discharge switches 7, and a cell discharge control unit 8.

The assembled battery 1 is a battery system in which n−1 battery cells are connected in series, and which is controlled and monitored by the battery system monitoring device 2. N cell voltage detection and discharge lines CL1 to CLn connected to positive electrodes and negative electrodes of the battery cells of the assembled battery 1 are respectively branched to n cell voltage detection lines SL1 to SLn and n cell voltage discharge lines BL1 to BLn. The cell voltage detection lines SL1 to SLn are connected to the cell voltage monitoring IC 5 via the filter circuits 3, and the cell voltage discharge lines BL1 to BLn are connected to the cell voltage monitoring IC 5 via the discharge resistors 4.

The filter circuit 3 is a filter circuit for removing high frequency noise superimposed on a voltage signal of each battery cell to be input to the cell voltage monitoring IC 5 from the cell voltage detection lines SL1 to SLn, and is constituted by a resistor and a capacitor provided for each of the cell voltage detection lines SL1 to SLn. The filter circuit 3 is provided between each branch point of the cell voltage detection lines SL1 to SLn and the cell voltage discharge lines BL1 to BLn and the cell voltage monitoring IC 5 at each of the cell voltage detection lines SL1 to SLn.

The discharge resistor 4 is a resistive element for adjusting a discharge current flowing through each of the discharge lines BL1 to BLn during discharge, and is provided between each branch point of the cell voltage detection lines SL1 to SLn and the cell voltage discharge lines BL1 to BLn and the cell voltage monitoring IC 5 at each of the cell voltage discharge lines BL1 to BLn.

A power terminal VCC of the cell voltage monitoring IC 5 is connected to the uppermost side of the assembled battery 1, that is, a positive electrode side of the battery cell disposed at the highest potential side by a power line PL of the cell voltage monitoring IC 5. A GND terminal of the cell voltage monitoring IC 5 is connected to the lowermost side of the assembled battery 1, that is, a negative electrode side of the battery cell disposed at the lowest potential side by a GND line GL of the cell voltage monitoring IC 5.

Although FIG. 1 illustrates the example in which the n−1 battery cells are connected in series in the assembled battery 1, the configuration of the assembled battery 1 may be another configuration in which the battery cells connected in parallel are further connected in series. The number of battery cells is not limited.

The cell voltage monitoring IC 5 detects voltages of the battery cells by the n cell voltage detection lines SL1 to SLn branched from the n cell voltage detection and discharge lines CL1 to CLn. The battery system monitoring device 2 executes a predetermined operation for controlling and monitoring the assembled battery 1 based on the voltage detection result of the battery cells using the cell voltage monitoring IC 5. For example, when the state of charge (SOC) of each battery cell is estimated and a charge state varies between the battery cells, the cell discharge switch 7 corresponding to the cell voltage discharge line of the battery cell to be discharged among the cell voltage discharge lines BL1 to BLn is controlled. Then, cell discharge currents through the cell voltage discharge lines BL1 to BLn flow, and thus, discharging for equalizing the states of charge of the battery cells is performed. In addition, the battery system monitoring device 2 performs various processes and controls based on the voltages of the battery cells detected by the cell voltage monitoring IC 5.

The above-described battery system monitoring device performs similar processes and controls in comparative examples and embodiments described below.

### COMPARATIVE EXAMPLE

In the battery system monitoring device, it is considered that a separate battery control board corresponds to each number of cells in order to correspond to any number of cells. However, when separate battery control boards are used, production costs and development costs are increased. In order to reduce the costs, it is required to realize the battery control board independent of the number of cells, that is, it is required to commonly use the battery control board so as to correspond to any number of cells by changing the mounting of circuit components. In order to commonly use the battery control boards, it is necessary to adopt circuit configurations corresponding to the number of cells by changing the mounting of circuit components.

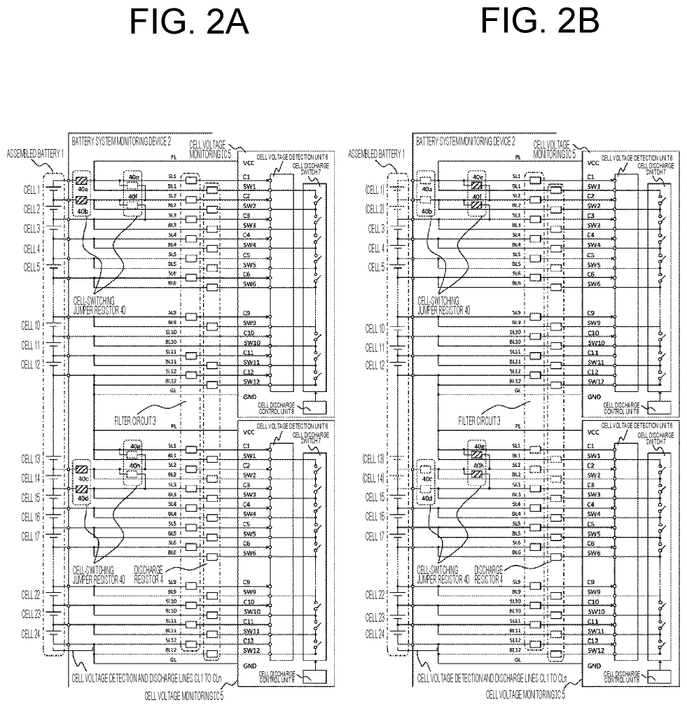

FIGS. 2(a) and 2(b) each illustrate a circuit configuration of a battery system monitoring device using common battery control boards according to a comparative example. An example in which two cell voltage monitoring ICs 5 for 12 cells are used as common battery control boards will be described. FIG. 2(a) is a circuit configuration diagram illustrating a case where common battery control boards are used for 24 cells. FIG. 2(b) is a circuit configuration diagram illustrating a case where the common battery control boards are used for 20 cells. It is assumed that the 20-cell assembled battery in FIG. 2(b) is an assembled battery in which the cells 1, 2, 13, and 14 are not provided and cell units corresponding to the cells 1, 2, 13, and 14 are short-circuited.

Jumper resistors 40a, 40b, 40c, and 40d on the common battery control boards are cell-switching jumper resistors as countermeasures against short-circuiting of the battery cells, which will be described below.

Jumper resistors 40e and 40f are jumper resistors constituting a power line PL for supplying power to the upper cell voltage monitoring IC 5 in the case of 20 cells, and jumper resistors 40g and 40h are jumper resistors constituting a cell voltage detection and discharge line CL of the lower cell voltage monitoring IC 5 in the case of 20 cells.

The circuit configuration for 24 cells illustrated in FIG. 2(a) is a configuration in which the jumper resistors 40a, 40b, 40c, and 40d are mounted and the jumper resistors 40e, 40f, 40g, and 40h are not mounted.

The circuit configuration for 20 cells illustrated in FIG. 2(b) is a configuration in which the jumper resistors 40e, 40f, 40g, and 40h are mounted and the jumper resistors 40a, 40b, 40c, and 40d are not mounted.

Here, the jumper resistors 40a, 40b, 40c, and 40d will be described. A problem when the battery control boards of the battery system monitoring device 2 are used in common is the short-circuiting of the battery cells on the battery control boards due to an incorrect connection between the assembled battery 1 and the battery system monitoring device 2.

When the number of cells in the assembled battery is less than the number of cells in the corresponding circuit configuration on the common battery control board, the problem of short-circuiting of the battery cell does not occur even though the assembled battery 1 is incorrectly connected. However, when the number of cells in the assembled battery 1 is greater than the number of cells in the corresponding circuit configuration on the common battery control board, the battery cells are short-circuited on the battery control board. The example in FIG. 2(b) will be described. In a case where the jumper resistors 40a, 40b, 40c, and 40d are connected by wiring (when the jumper resistors 40a, 40b, 40c, and 40d are mounted), when the 24-cell assembled battery 1 is incorrectly connected to the battery control boards having the circuit configuration for 20 cells, the battery cells are short-circuited on the battery control board through the jumper resistors 40e, 40f, 40g, and 40h. In order to prevent the short-circuiting of the battery cell on the battery control board, it is necessary to disconnect the wiring by the jumper resistors such that the short-circuiting of the battery cells does not occur even though the battery cell is connected to an unused part of the battery due to the incorrect connection.

As described above, when the number of cells in the assembled battery 1 is greater than the number of cells corresponding to the battery control board, the jumper resistors 40a, 40b, 40c, and 40d are jumper resistors for disconnecting the wiring such that the short-circuiting does not occur even though the battery cell is connected. Even though the 24-cell assembled battery 1 is incorrectly connected to the battery control board for 20 cells, the jumper resistors 40a, 40b, 40c, and 40d are not mounted, and thus, the wiring is disconnected. Accordingly, the short-circuiting of the battery cells does not occur.

Meanwhile, a problem in the battery system monitoring device when the battery control board is used in common is detection accuracy of the cell voltage. The detection accuracy of the cell voltage is an important element of electrical characteristics in the battery system monitoring device 2, but the cell-switching jumper resistors as the countermeasures against the short-circuiting of the battery cells greatly affects the detection accuracy of the cell voltage.

The detection accuracy of the cell voltage is deteriorated due to voltage drop caused by a current flowing through an impedance (for example, an overcurrent protection fuse resistor, a wire harness resistor, a connector contact resistor, or a board wiring resistor (not illustrated)) of the common path part (cell voltage detection and discharge line CL) before the branch part of the cell voltage detection line SL and the cell voltage discharge line BL.

When the cell is not discharged, since a leakage current flowing through the cell voltage monitoring IC 5 is several μA, the effect of the voltage drop is small. However, when the cell is discharged, since a discharge current having several tens of mA flows, the voltage drop due to the resistor of the common path part before the branch part of the cell voltage detection line SL and the cell voltage discharge line BL is increased, and thus, a voltage detection error is several tens of mV. This effect is increased as the specification of the cell discharge current becomes larger. A general jumper resistor has a resistance value of 50 to 100 mO. When the cell-switching jumper resistor is mounted at the cell voltage detection and discharge line CL, the impedance of the cell voltage detection and discharge line CL is increased, and thus, the detection accuracy of the cell voltage which is an important element of the electrical characteristics of the battery system monitoring device is deteriorated.

Although the detection accuracy of the cell voltage deteriorates as described above in the comparative example, the detection accuracy of the cell voltage can be increased in each embodiment to be described below.

### First Embodiment

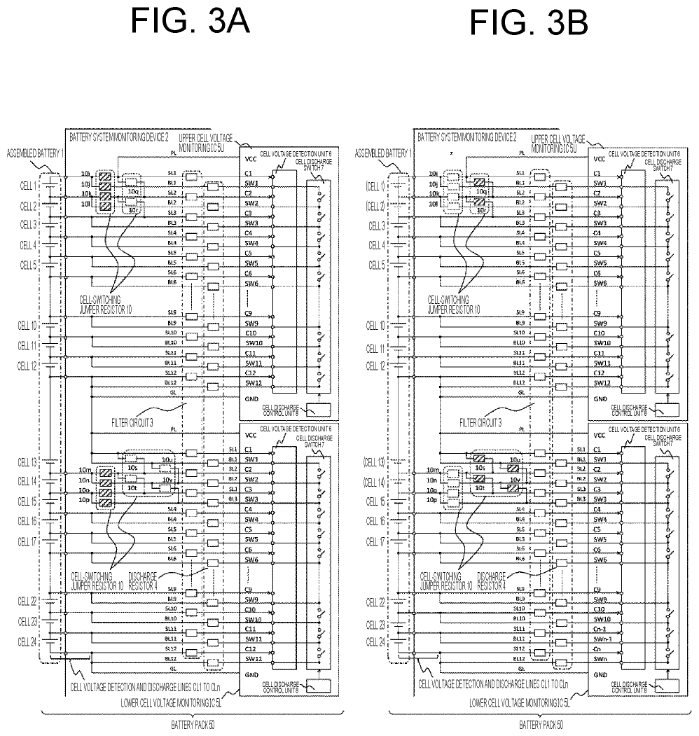

FIGS. 3(a) and 3(b) each illustrate a circuit configuration of a battery system monitoring device according to a first embodiment of the present invention. An example in which two cell voltage monitoring ICs for 12 cells are used as common battery control boards will be described. FIG. 3(a) is a circuit configuration diagram illustrating a case where the common battery control boards are used for 24 cells. FIG. 3(b) is a circuit configuration diagram illustrating a case where common battery control boards are used for 20 cells.

In the circuit configurations illustrated in FIGS. 3(a) and 3(b), cell voltage detection and discharge lines CL1 to CLn connected to positive and negative electrodes of battery cells are branched to cell voltage detection lines SL1 to SLn and cell voltage discharge line BL1 to BLn. The cell voltage detection lines SL1 to SLn are connected to cell voltage detection units 6 of cell voltage monitoring ICs 5U and 5L via filter circuits 3. The cell voltage discharge lines BL1 to BLn are connected to cell discharge switches 7 (cell discharge circuits) through discharge resistors 4.

Jumper resistors 10i, 10k, 10m, and 10o are mounted at the cell voltage detection lines SL after branch parts of the cell voltage detection lines SL and the cell voltage discharge lines BL, and jumper resistors 10j, 10l, 10n, and 10p are mounted at the cell voltage discharge lines BL after branch parts of the cell voltage detection lines SL and the cell voltage discharge lines BL. The jumper resistors 10i, 10k, 10m, and 10o, and the jumper resistors 10j, 10l, 10n, and 10p are first jumper resistors.

Jumper resistors 10q and 10r are jumper resistors for supplying power to the upper cell voltage monitoring IC 5U having the circuit configuration for 20 cells, and a power terminal VCC of the upper cell voltage monitoring IC 5U is connected to the cell voltage detection line SL of the uppermost cell by a power line PL. Jumper resistors 10q and 10r are mounted at connection lines between the cell voltage detection lines SL adjacent to each other. Although the jumper resistors 10q and 10r are mounted at the connection lines between the cell voltage detection lines SL in FIGS. 3(a) and 3(b), when the power is supplied to the upper cell voltage monitoring IC 5U by the cell voltage discharge line BL, the jumper resistors 10q and 10r may be mounted at connection lines between the cell voltage discharge lines BL.

In the circuit configurations illustrated in FIGS. 3(a) and 3(b), the cell voltage detection and discharge line CL on the positive electrode side of the uppermost cell of the lower cell voltage monitoring IC 5L is the cell voltage detection and discharge line CL used in common with the negative electrode side of the lowermost cell of the upper cell voltage monitoring IC 5U. The jumper resistors 10s and 10t are mounted at connection lines between the cell voltage detection lines SL after a branch part of the cell voltage discharge line BL and the cell voltage detection line SL of the uppermost cell of the lower cell voltage monitoring IC 5L. The jumper resistors 10u and 10v are mounted at connection lines between the cell voltage discharge lines BL after a branch part of the cell voltage discharge line BL and the cell voltage detection line SL of the uppermost cell of the lower cell voltage monitoring IC 5L. The jumper resistors 10q, 10r, 10s, 10t, 10u, and 10v are second jumper resistors.

In the circuit configuration for 24 cells illustrated in FIG. 3(a), the first jumper resistors 10i, 10j, 10k, 10l, 10m, 10n, 10o, and 10p are mounted, and the second jumper resistors 10q, 10r, 10s, 10t, 10u, and 10v are not mounted.

In the circuit configuration for 20 cells illustrated in FIG. 3(b), an assembled battery is assumed in which the cells 1, 2, 13, and 14 are unused and the cell units of the cells 1, 2, 13, and 14 are short-circuited. Further, the second jumper resistors 10q, 10r, 10s, 10t, 10u, and 10v are mounted and the first jumper resistors 10i, 10j, 10k, 10l, 10m, 10n, 10o, and 10p are not mounted.

For example, even though the assembled battery of 24 cells is incorrectly connected to the battery control board having the circuit configuration for 20 cells illustrated in FIG. 3(b), since the wiring is disconnected by the first jumper resistors 10i, 10j, 10k, 10l, 10m, 10n, 10o, and 10p, the short-circuiting of the battery cells does not occur.

It is possible to correspond to the circuit configurations for 20 cells to 24 cells by changing the mounting of the jumper resistors. For example, in order to achieve the circuit configuration for 22 cells, the jumper resistors 10i, 10j, 10m, and 10n are not mounted and the jumper resistors 10k, 10l, 10o, and 10p are mounted, the jumper resistors 10q, 10s, and 10u are mounted, and the jumper resistors 10r, 10t, and 10v are not mounted.

The example in which the first jumper resistors are mounted or are not mounted at two of cell voltage detection lines and cell voltage discharge lines has been described. However, the first jumper resistors may be mounted or may not be mounted at at least one line of the plurality of cell voltage detection lines and at least one line of the plurality of cell voltage discharge lines depending on whether or not each of the battery cells is used.

In a battery pack 50, the battery system monitoring device 2 described in the first embodiment and a battery group constituting the assembled battery 1 by connecting a plurality of battery cells in series are mounted in the same package.

Although the circuit configuration of the common battery control board corresponding to the assembled battery of up to 24 cells has been described with reference to FIG. 3, it is also possible to correspond to an assembled battery including 24 or more cells by increasing the number of channels of the cell voltage monitoring IC 5 and the number of cell voltage monitoring ICs 5 in the same manner. In this case, the jumper resistors are mounted at the cell voltage detection lines SL and the cell voltage discharge lines BL on a high potential side of the assembled battery managed by the cell voltage monitoring IC 5.

Next, the detection accuracy of the cell voltage which is the important element of the electrical characteristics in the battery system monitoring device will be described.

As in the common battery control board illustrated in the comparative example of FIG. 2, in a case where the cell-switching jumper resistors are mounted at the cell voltage detection and discharge lines CL before the branch parts of the cell voltage detection lines SL and the cell voltage discharge lines BL, when the cell is not discharged, since the leakage current flowing through the cell voltage monitoring IC 5 has several μA, the effect of the voltage drop is small.

However, when the cell is discharged, since the discharge current having several tens of mA flows, the voltage drop due to the impedance of the cell voltage detection and discharge lines CL is increased. A general jumper resistor has a resistance value of 50 to 100 mO, and the detection error of the cell voltage due to the jumper resistors is several mV. There is a problem that this effect is increased as the specification of the cell discharge current becomes larger.

Specifically, the deterioration of the detection accuracy of the cell voltage when the cell is discharged will be described. For example, when a resistance value of a discharge resistor 4 is 30 O, a cell voltage is 3.6 V, a resistance value of the cell voltage detection and discharge line CL is 100 mO, the jumper resistor mounted at the cell voltage detection and discharge line CL has 50 mO, and an on-resistor of the cell discharge switch 7 has 2 O, a cell discharge current I is 57.78 mA by Equation (1), and a cell voltage detection value V is 17.34 mV by Equation (2).

I=3.6/((30+0.1+0.05)×2+2)=0.05778 (1)

V=0.05778×(0.1+0.05)×2=0.01734 (2)

Meanwhile, when there is no jumper resistor at the cell voltage detection and discharge line CL, the cell discharge current I is 57.78 mA by Equation (3), and the cell voltage detection value V is 11.58 mV by Equation (4).

I=3.6/((30+0.1)×2+2)=0.05788 (3)

V=0.05788×(0.1)×2=0.01158 (4)

That is, an error of 5.76 mV is generated in the detection accuracy of the cell voltage when the cell is discharged by the jumper resistor at the cell voltage detection and discharge line CL, and thus, the detection accuracy is deteriorated.

In the present embodiment, the first jumper resistors 10i, 10j, 10k, 10l, 10m, 10n, 10o, and 10p are provided after the branch parts of the cell voltage detection lines SL and the cell voltage discharge lines BL. Thus, when the cell is discharged, the discharge current flows through the jumper resistors 10j, 10l, 10n, and 10p of the cell voltage discharge lines BL. However, since the discharge current does not flow through the jumper resistors 10i, 10k, 10m, and 10o of the cell voltage detection line SL, the deterioration of the detection accuracy of the cell voltage at the cell-switching jumper resistor mounted as the countermeasure against the short-circuiting of the battery does not occur in principle. In this embodiment, it is possible to increase the detection accuracy of the cell voltage by removing the effect using the jumper resistor at the cell voltage detection and discharge line CL illustrated in the comparative example.

### Second Embodiment

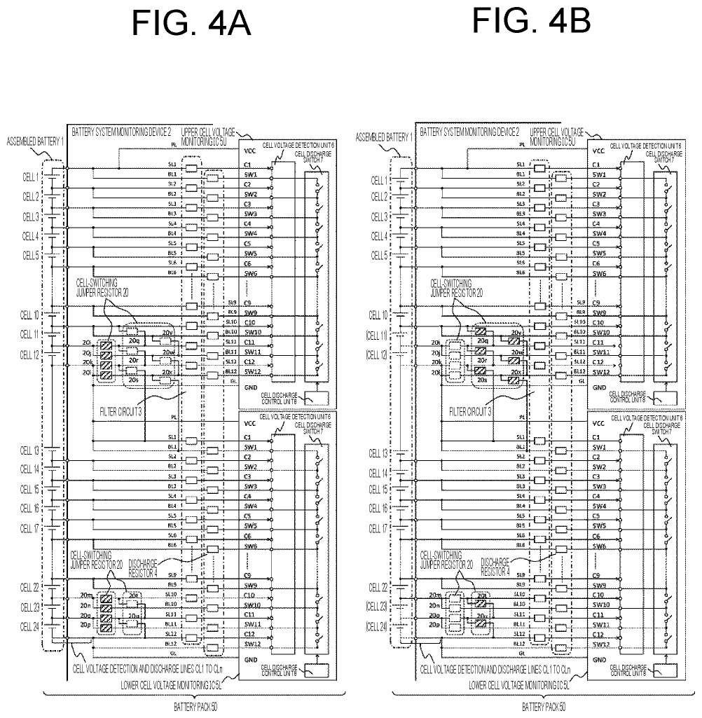

FIGS. 4(a) and 4(b) each illustrate a circuit configuration of a battery system monitoring device according to a second embodiment. In the first embodiment, as illustrated in the circuit configuration diagram for 20 cells in FIG. 3(b), the battery cells on the high potential side of the cell voltage monitoring ICs 5U and 5L are unused and the jumper resistors are integrated on the high potential side of the cell voltage monitoring ICs 5U and 5L. In the present embodiment, as illustrated in FIG. 4, a circuit configuration is used in which the battery cells on a low potential side of the cell voltage monitoring ICs 5U and 5L are unused, and the jumper resistors are integrated on the low potential side of the cell voltage monitoring ICs 5U and 5L.

In FIGS. 4(a) and 4(b), an example in which two cell voltage monitoring ICs for 12 cells are used as common battery control boards will be described. FIG. 4(a) is a circuit configuration diagram illustrating a case where the common battery control boards are used for 24 cells. FIG. 4(b) is a circuit configuration diagram illustrating a case where the common battery control boards are used for 20 cells. In these drawings, the same portions as those in FIGS. 3(a) and 3(b) illustrated in the first embodiment will be denoted by the same reference numerals, and the description thereof will be omitted.

In the circuit configuration for 20 cells illustrated in FIG. 4(b), an assembled battery is assumed in which the cells 11, 12, 23, and 24 are unused and the cell units of the cells 11, 12, 23, and 24 are short-circuited.

Jumper resistors 20i, 20k, 20m, and 20o are mounted at the cell voltage detection lines SL after the branch parts of the cell voltage detection lines SL and the cell voltage discharge lines BL, and jumper resistors 20j, 20l, 20n, and 20p are mounted at the cell voltage discharge lines BL after the branch parts of the cell voltage detection lines SL and the cell voltage discharge lines BL. The jumper resistors 20i, 20k, 20m, and 20o and the jumper resistors 20j, 20l, 20n, and 20p are first jumper resistors.

Jumper resistors 20t and 20u are jumper resistors for supplying GND to the lower cell voltage monitoring IC 5L having a circuit configuration for 20 cells. A GND terminal of the lower cell voltage monitoring IC 5L is connected from a GND line GL to the cell voltage detection line SL of the lowermost cell. The jumper resistors 20t and 20u are mounted at connection lines between the cell voltage detection lines SL adjacent to each other. Although the jumper resistors have been mounted between the cell voltage detection lines SL in FIG. 4, when the GND of the lower cell voltage monitoring IC 5L is supplied from the cell voltage discharge line BL, the jumper resistors may be connected between the cell voltage discharge lines BL.

In the circuit configurations illustrated in FIGS. 4(a) and 4(b), the cell voltage detection and discharge line CL on the positive electrode side of the uppermost cell of the lower cell voltage monitoring IC 5L is the cell voltage detection and discharge line CL used in common with the negative electrode side of the lowermost cell of the upper cell voltage monitoring IC 5U. The jumper resistors 20q, 20r, and 20s are mounted at connection lines between the cell voltage detection lines SL after branch parts of the cell voltage discharge lines BL and the cell voltage detection lines SL of the uppermost cell of the lower cell voltage monitoring IC 5L. The jumper resistors 20v, 20w, and 20x are mounted at connection lines between the cell voltage discharge lines BL adjacent to each other after branch parts of the cell voltage discharge lines BL and the cell voltage detection lines SL of the uppermost cell of the lower cell voltage monitoring IC 5L. The jumper resistors 20q, 20r, 20s, 20t, 20u, 20v, 20w, and 20x are second jumper resistors.

In the circuit configuration for 24 cells illustrated in FIG. 4(a), the first jumper resistors 20i, 20j, 20k, 20l, 20m, 20n, 20o, and 20p are mounted and the second jumper resistors 20q, 20r, 20s, 20t, 20u, 20v, 20w, and 20x are not mounted.

In the circuit configuration for 20 cells illustrated in FIG. 4(b), the second jumper resistors 20q, 20r, 20s, 20t, 20u, 20v, 20w, and 20x are mounted and the first jumper resistors 20i, 20j, 20k, 20l, 20m, 20n, 20o, and 20p are not mounted.

In the battery pack 50, the battery system monitoring device described in the second embodiment and a battery group constituting the assembled battery 1 by connecting a plurality of battery cells in series are mounted in the same package.

Although the circuit configuration of the common battery control board corresponding to the assembled battery of up to 24 cells has been described with reference to FIG. 4, it is also possible to correspond to an assembled battery including any number of cells by increasing or decreasing the number of channels of the cell voltage monitoring IC 5 and the number of cell voltage monitoring ICs 5. In this case, the jumper resistors are mounted at the cell voltage detection lines SL and the cell voltage discharge lines BL on the low potential side of the assembled battery managed by the cell voltage monitoring IC 5.

According to the present embodiment, since the cell voltage detection and discharge lines CL are branched to the cell voltage detection lines SL and the cell voltage discharge lines BL and the cell-switching jumper resistors are mounted at the branched cell voltage detection lines SL and cell voltage discharge lines BL, it is possible to increase the detection accuracy of the cell voltage when the cell is discharged.

### Third Embodiment

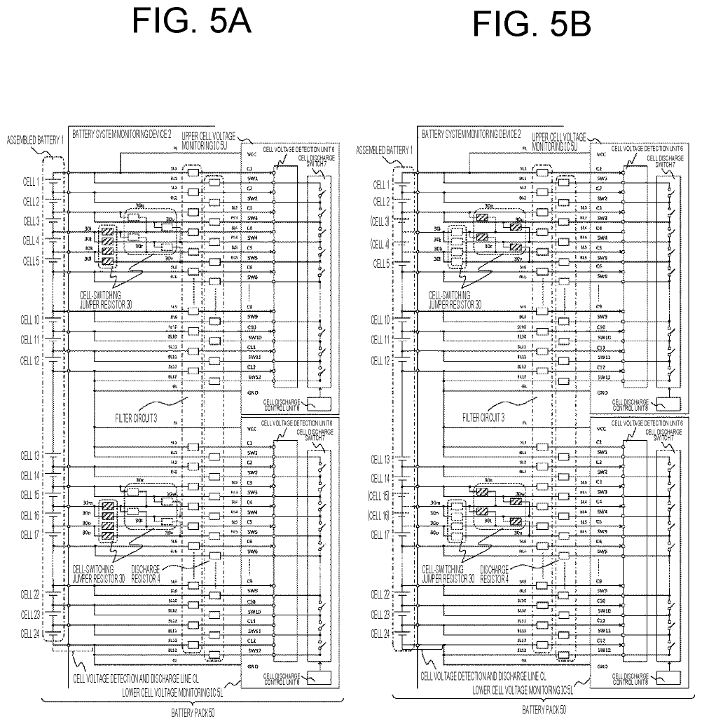

FIGS. 5(a) and 5(b) each illustrate a circuit configuration of a battery system monitoring device according to a third embodiment. In the first embodiment, as illustrated in the circuit configuration diagram for 20 cells in FIG. 3(b), the battery cells on the high potential side of the cell voltage monitoring ICs 5U and 5L are unused and the jumper resistors are integrated on the upper side of the cell voltage monitoring ICs 5U and 5L. In the present embodiment, as illustrated in FIG. 5, a configuration is used in which the battery cells on an intermediate potential side of the cell voltage monitoring ICs 5U and 5L are unused and the jumper resistors are integrated on the intermediate potential side of the cell voltage monitoring ICs 5U and 5L.

In FIGS. 5(a) and 5(b), an example in which two cell voltage monitoring ICs for 12 cells are used as common battery control boards will be described. FIG. 5(a) is a circuit configuration diagram in which common battery control boards are used for 24 cells. FIG. 5(b) is a circuit configuration diagram in which common battery control boards are used for 20 cells. In these drawings, the same portions as those in FIGS. 3(a) and 3(b) illustrated in the first embodiment will be denoted by the same reference numerals, and the description thereof will be omitted.

In the circuit configuration for 20 cells illustrated in FIG. 5(b), an assembled battery is assumed in which the cells 3, 4, 15, and 16 are unused and the cell units of the cells 3, 4, 15, and 16 are short-circuited.

Jumper resistors 30i, 30k, 30m, and 30o are mounted at the cell voltage detection lines SL after the branch parts of the cell voltage detection lines SL and the cell voltage discharge lines BL, and jumper resistors 30j, 30l, 30n, and 30p are mounted at the cell voltage discharge lines BL after the branch parts of the cell voltage detection lines SL and the cell voltage discharge lines BL. The jumper resistors 30i, 30k, 30m, and 30o, and the jumper resistors 30j, 30l, 30n, and 30p are first jumper resistors.

In the circuit configurations illustrated in FIGS. 5(a) and 5(b), the jumper resistors 30q, 30r, 30s, and 30t are mounted at the connection lines between the cell voltage detection lines SL after the branch parts of the cell voltage discharge lines BL and the cell voltage detection lines SL of the cells on the intermediate potential side of the cell voltage monitoring ICs 5U and 5L. Jumper resistors 30u, 30v, 30w, and 30x are mounted at the connection lines between the cell voltage discharge lines BL after the branch parts of the cell voltage discharge lines BL and the cell voltage detection lines SL of the cells on the intermediate potential side of the cell voltage monitoring ICs 5U and 5L. The jumper resistors 30q, 30r, 30s, and 30t, and the jumper resistors 30u, 30v, 30w, and 30x are second jumper resistors.

In the circuit configuration for 24 cells illustrated in FIG. 5(a), the first jumper resistors 30i, 30j, 30k, 30l, 30m, 30n, 30o, 30p are mounted, and the second jumper resistors 30q, 30r, 30s, 30t, 30u, 30v, 30w, 30x are not mounted.

In the circuit configuration for 20 cells illustrated in FIG. 5(b), the second jumper resistors 30q, 30r, 30s, 30t, 30u, 30v, 30w, and 30x are mounted and the first jumper resistors 30i, 30j, 30k, 30l, 30m, 30n, 30o, and 30p are not mounted.

In the battery pack 50, the battery system monitoring device 2 described in the third embodiment and a battery group constituting the assembled battery 1 by connecting a plurality of battery cells in series are mounted in the same package.

Although the circuit configuration of the common battery control board corresponding to the assembled battery of up to 24 cells has been described with reference to FIG. 5, it is also possible to correspond to an assembled battery including any number of cells by increasing or decreasing the number of channels of the cell voltage monitoring IC 5 and the number of cell voltage monitoring ICs 5. In this case, the jumper resistors are mounted at the cell voltage detection lines SL and the cell voltage discharge lines BL on the intermediate potential side of the assembled battery managed by the cell voltage monitoring IC 5.

According to the present embodiment, since the cell voltage detection and discharge lines CL are branched to the cell voltage detection lines SL and the cell voltage discharge lines BL and the cell-switching jumper resistors are mounted at the branched cell voltage detection lines SL and cell voltage discharge lines BL, it is possible to increase the detection accuracy of the cell voltage when the cell is discharged.

According to the above-described embodiments, the following advantageous effects are obtained.

(1) A battery system monitoring device 2 includes a cell voltage monitoring IC 5 that detects cell voltages of a plurality of chargeable and dischargeable battery cells constituting an assembled battery by being connected in series and discharges the cell voltages of the battery cells so as to correspond to the battery cells, connection lines CL1 to CLn which are connected to positive electrodes and negative electrodes of the battery cells, cell voltage detection lines SL1 to SLn that are branched from the connection lines CL1 to CLn, and are connected the cell voltage monitoring IC 5 in order to detect the cell voltages of the battery cells, cell voltage discharge lines BL1 to BLn that are branched from the connection lines CL1 to CLn, and are connected to the cell voltage monitoring IC 5 in order to discharge the cell voltages of the battery cells, and first jumper resistors 10i to 10p that are mounted or are not mounted at at least one line of a plurality of the cell voltage detection lines SL1 to SLn and at least one line of a plurality of the cell voltage discharge lines BL1 to BLn depending on whether or not each of the battery cells is used. Accordingly, it is possible to increase the detection accuracy of the cell voltage when the cell is discharged.

(2) The battery system monitoring device 2 further includes second jumper resistors 10q to 10v that are mounted at lines which connect the cell voltage detection lines SL1 to SLn adjacent to each other or the cell voltage discharge lines BL1 to BLn adjacent to each other when the battery cell is not used. Accordingly, the battery control board is used in common, and thus, it is possible to increase the detection accuracy of the cell voltage when the cell is discharged.

(3) In the battery system monitoring device 2, the first and second jumper resistors 10i to 10p and 10q and 10v are mounted at the cell voltage detection lines SL1 to SLn and the cell voltage discharge lines BL1 to BLn on a high potential side of an assembled battery including cells 1 to 12 and an assembled battery including cells 13 to 24. Accordingly, the battery control board on the high potential side of the assembled battery is used in common, and thus, it is possible to increase the detection accuracy of the cell voltage when the cell is discharged.

(4) In the battery system monitoring device 2, the first and second jumper resistors 10i to 10p and 10q to 10v are mounted at the cell voltage detection lines SL1 to SLn and the cell voltage discharge lines BL1 to BLn on a low potential side of an assembled battery including cells 1 to 12 and an assembled battery including cells 13 to 24. Accordingly, the battery control board on the low potential side of the assembled battery is used in common, and thus, it is possible to increase the detection accuracy of the cell voltage when the cell is discharged.

(5) In the battery system monitoring device 2, the first and second jumper resistors 10i to 10p and 10q to 10v are mounted at the cell voltage detection lines SL1 to SLn and the cell voltage discharge lines BL1 to BLn on an intermediate potential side of an assembled battery including cells 1 to 12 and an assembled battery including cells 13 to 24. Accordingly, the battery control board on the intermediate potential side of the assembled battery is used in common, and thus, it is possible to increase the detection accuracy of the cell voltage when the cell is discharged.

(6) A battery pack includes the battery system monitoring device 2 according to any one of (1) to (5), and a battery group that constitutes an assembled battery by connecting a plurality of the battery cells in series. Accordingly, it is possible to provide the battery pack with increased detection accuracy of the cell voltage when the cell is discharged.

(Modification)

The present invention can be implemented by modifying the above-described first to third embodiments as follows.

(1) Although it has been described that two cell voltage monitoring ICs are used, the number of cell voltage monitoring ICs may be one or three or more depending on the number of cells of the assembled battery.

The present invention is not limited to the above-described embodiments, and other forms conceivable within the scope of the technical idea of the present invention are also included in the scope of the present invention as long as the characteristics of the present invention are not impaired. The above-described embodiments and modification may be combined.

### REFERENCE SIGNS LIST

1 assembled battery
2 battery system monitoring device
3 filter circuit
4 discharge resistor
5 cell voltage monitoring IC
6 cell voltage detection unit
7 cell discharge switch
8 cell discharge control unit
50 battery pack
10i to 10v jumper resistor
20i to 20x jumper resistor
30i to 30x jumper resistor
40a to 40h jumper resistor
CL1 to CLn cell voltage detection and discharge line
SL1 to SLn cell voltage detection line
BL1 to BLn cell voltage discharge line
PL cell voltage monitoring IC power line
GL cell voltage monitoring
IC GND line
VCC cell voltage monitoring IC power terminal
GND cell voltage monitoring IC GND terminal
C1 to Cn cell voltage monitoring IC cell voltage detection terminal
SW1 to SWn cell voltage monitoring IC cell discharge terminal

1. A battery system monitoring device comprising:
a cell voltage monitoring circuit that detects cell voltages of a plurality of chargeable and dischargeable battery cells constituting an assembled battery by being connected in series and discharges the cell voltages of the battery cells so as to correspond to the battery cells;
connection lines which are connected to positive electrodes and negative electrodes of the battery cells;
cell voltage detection lines that are branched from the connection lines, and are connected the cell voltage monitoring circuit in order to detect the cell voltages of the battery cells;
cell voltage discharge lines that are branched from the connection lines, and are connected to the cell voltage monitoring circuit in order to discharge the cell voltages of the battery cells; and
first jumper resistors that are mounted or are not mounted at at least one line of a plurality of the cell voltage detection lines and at least one line of a plurality of the cell voltage discharge lines depending on whether or not each of the battery cells is used.

2. The battery system monitoring device according to claim 1, further comprising second jumper resistors that are mounted at lines which connect the cell voltage detection lines adjacent to each other or the cell voltage discharge lines adjacent to each other when the battery cell is not used.

3. The battery system monitoring device according to claim 2, wherein the first and second jumper resistors are mounted at the cell voltage detection lines and the cell voltage discharge lines on a high potential side of the assembled battery.

4. The battery system monitoring device according to claim 2, wherein the first and second jumper resistors are mounted at the cell voltage detection lines and the cell voltage discharge lines on a low potential side of the assembled battery.

5. The battery system monitoring device according to claim 2, wherein the first and second jumper resistors are mounted at the cell voltage detection lines and the cell voltage discharge lines on an intermediate potential side of the assembled battery.

6. A battery pack comprising:
the battery system monitoring device according to claim 1; and
a battery group that constitutes an assembled battery by connecting a plurality of the battery cells in series.
